(19) United States
(12) Patent Application Publication
(10) Pub. No.: US 2010/0067438 A1
(43) Pub. Date: Mar. 18, 2010

(54) COMMUNICATION METHOD AND, TERMINAL APPARATUS AND BASE STATION APPARATUS USING THE METHOD

(75) Inventors: Ken Nakaoka, Aichi (JP); Yasutaka Ogawa, Hokkiado (JP); Takeo Ohgane, Hokkaido (JP); Toshihiko Nishimura, Hokkaido (JP)

Correspondence Address: MCDERMOTT WILL & EMERY LLP, 600 13TH STREET, N.W., WASHINGTON, DC, 20005-3096, US

(73) Assignee: SANYO ELECTRIC CO.,LTD, OSAKA (JP)

(21) Appl. No.: 12/530,971

(22) PCT Filed: Mar. 19, 2008
(86) PCT No.: PCT/JP2008/000663

§ 371 Date: Sep. 11, 2009

(30) Foreign Application Priority Data
Mar. 22, 2007 (JP) 2007-074334

(51) Int. Cl. H04W 4/00

(52) U.S. Cl. 370/328

(57) ABSTRACT

When a control unit receives an authentication request from a terminal apparatus, the control unit transmits an authentication response to the terminal apparatus. When it receives a connection request from the terminal apparatus to which the authentication response has been transmitted, the control unit transmits a connection response to the terminal apparatus. The control unit carries out data communication with the terminal apparatus to which the connection response has been transmitted. When it receives a notification indicating that a connection has already been granted by another base station apparatus, in substitution for the authentication request, the control unit carries out data communication with the terminal apparatus.

### TECHNICAL FIELD

The present invention relates to a communication technology, and it particularly relates to a method for communicating signals between a base station apparatus and a terminal apparatus, and the terminal apparatus and the base station apparatus using the communication method.

### DISCLOSURE OF INVENTION

### Technical Problem

A road-to-vehicle communication system includes a mobile station apparatus mounted on a vehicle and a base station apparatus placed on a street. A communication range in the road-to-vehicle communication system is limited. And if a communication range larger than the limited communication range is required, a plurality of base station apparatuses are placed and linked together. Provision of a management apparatus for collectively managing a plurality of base station apparatuses simplifies authentication processing performed when a mobile station apparatus is handed over among the base station apparatuses managed by this management apparatus.

In a wireless communication system structured by a base station apparatus and a terminal apparatus, a connection processing is generally performed prior to a communication. An example of such a connection processing is executed as follows. The terminal apparatus transmits an authentication request signal to the base station apparatus. And when the base station apparatus executes the authentication processing, the base station apparatus transmits an authentication response signal to the terminal apparatus. Then the terminal apparatus transmits a connection request signal to the base station apparatus. And when the base station apparatus executes the connection processing, the base station apparatus transmits a connection response signal to the terminal apparatus. Note that the meaning of the term “connection processing” may be twofold. That is, there are a case where the connection processing is executed after the authentication processing and a case where the authentication and the connection processing are generically referred to as “connection processing. Hereinbelow, the term “connection processing” will be used without distinction between the two cases.

A predetermined period of time is required from the start of a connection processing until the completion thereof. For instance, if a terminal apparatus is mounted on the vehicle and the terminal apparatus travels across a communication area formed by the base station apparatus as in the above-mentioned road-to-vehicle communication system, there may be cases where the terminal apparatus moves out of the communication area even when the communication starts after the connection processing has been completed. With such a processing repeated, data communication between the base station apparatus and the terminal apparatus is disconnected over a certain period of time whenever the hand-over is performed, so that the execution time of the data communication between the base station apparatus and the terminal apparatus is shortened.

The present invention has been made in view of such circumstances and a general purpose thereof is to provide a communication technique by which to shorten the period needed for connection processing between a base station apparatus and a terminal apparatus in a communication area formed by the base station apparatus.

In order to resolve the above problems, a base station apparatus according to one embodiment of the present invention comprises: a connection processing unit including: a first transmitting means which transmits an authentication response to a terminal apparatus when an authentication request is received from said terminal apparatus; and a second transmitting means which transmits a connection response to a terminal apparatus when a connection request is received from said terminal apparatus to which the authentication response has been transmitted; and a communication unit which carries out data communication with the terminal apparatus to which the connection processing unit has transmitted the connection response. When the connection processing unit receives, from a terminal apparatus, a notification indicating that a connection has already been permitted by another base station apparatus in substitution for the authentication request, the communication unit carries out data communication with said terminal apparatus.

According to this embodiment, when, instead of the authentication request, the notification indicating that an access has already been granted by another base station apparatus is received, data communication is carried out with said terminal apparatus, so that the connection processing is skipped. Thus the length of period required for the connection processing between the base station apparatus and the terminal apparatus can be shortened.

The connection processing unit and the communication unit may receive, from a terminal signal, a packet signal containing the notification indicating that a connection has already been permitted by another base station apparatus and a data signal. In such a case, the notification indicating that a connection has already been permitted and the data signal are contained in the same packet signal, so that the transmission efficiency can be improved.

The base station apparatus may further comprise a storage which stores beforehand information on another base station apparatus. When the information on another base station apparatus contained in the notification received by the connection processing unit is contained in the storage, the communication unit may carry out data communication with the terminal apparatus. In this case, the connection of the terminal apparatus is permitted according to the information stored, the safety provided by security can be improved.

Another embodiment of the present invention relates also to a base station apparatus. This apparatus comprises: a connection processing unit including: a first transmitting means which transmits an authentication response to a terminal apparatus when an authentication request is received from the terminal apparatus; and a second transmitting means which transmits a connection response to a terminal apparatus when a connection request is received from said terminal apparatus to which the authentication response has been transmitted; and a communication unit which carries out data communication with the terminal apparatus to which the connection processing unit has transmitted the connection response. The connection processing unit verifies a communication between another base station and the terminal apparatus, and the communication unit carries out data communication with the terminal apparatus whose communication with the another base station apparatus has been verified by connection processing unit even in the event that the connection processing unit has not transmitted the connection response to said terminal apparatus.

According to this embodiment, where the communication between another base station and the terminal apparatus has been verified but the connection response is not transmitted to this terminal apparatus, the connection processing is omitted by carrying out data communication with this terminal apparatus. Thus, the length of period required for the connection processing between the base station apparatus and the terminal apparatus can be reduced.

Still another embodiment of the present invention relates to a terminal apparatus. This apparatus comprises: a connection processing unit including: a first receiving means which receives an authentication response transmitted from a base station apparatus when an authentication request is transmitted to said base station apparatus; and a second receiving means which receives a connection response from a base station apparatus when a connection request is transmitted to said base station apparatus which has received the authentication response; and a communication unit which carries out data communication with the base station apparatus from which the connection processing unit has received the connection response. When the connection processing unit has already been permitted a connection by another base station apparatus, the communication unit transmits to the base station apparatus a notification indicating that the connection has been permitted, in substitution for the authentication request, and carries out data communication with the base station apparatus.

According to this embodiment, instead of the authentication request, the notification indicating that the connection has already been granted by another base station is transmitted, thereby omitting the connection processing. Hence, the length of period required for the connection processing between the base station and the terminal apparatus can be shortened.

Still another embodiment of the present invention relates also to a terminal apparatus. This terminal apparatus comprises: a connection processing unit including: a first receiving means which receives an authentication response transmitted from a base station apparatus when an authentication request is transmitted to said base station apparatus; and a second receiving means which receives a connection response from a base station apparatus when a connection request is transmitted to said base station apparatus which has received the authentication response; and a communication unit which carries out data communication with the base station apparatus from which the connection processing unit has received the connection response. When the connection processing unit has already been permitted a connection by another base station apparatus, the communication unit carries out data communication with the base station apparatus even in the event that said connection processing unit has not received the connection response from said base station apparatus; and when data communication is rejected by the base station apparatus, the communication unit transmits a notification indicating that a connection has already been permitted by another base station apparatus, in substitution for the authentication request, and carries out data communication with the base station apparatus.

According to this embodiment, instead of transmitting the authentication request, data communication is carried out. And if rejected, the notification indicating that the connection has already been granted by another base station apparatus will be transmitted so as to skip the connection processing. As a result, the length of period required for the connection processing between the base station apparatus and the terminal apparatus can be shortened.

The communication unit may transmit, to the base station apparatus, a packet signal containing the notification indicating that the connection has been permitted by another base station apparatus and a a data signal. In such a case, the notification indicating that a connection has already been permitted and the data signal are contained in the same packet signal, so that the transmission efficiency can be improved.

When a base station apparatus rejects data communication with the communication unit, the connection processing unit may transmit an authentication request to said base station apparatus. In this case, the authentication request packet is transmitted, so that the hand-over is carried out reliably.

Still another embodiment of the present invention relates to a communication method. This method comprises: transmitting an authentication response to a terminal when an authentication request is received from the terminal apparatus; transmitting a connection response to a terminal apparatus when a connection request is received from the terminal apparatus to which the authentication response has been transmitted; and carrying out data communication with the terminal to which the connection response has been transmitted. When a notification indicating that a connection has already been permitted by another base station apparatus is received, in substitution for the authentication request, from the terminal apparatus, the carrying out data communication carries out data communication with said terminal apparatus.

Still another embodiment of the present invention relates also to a communication method. This method comprises: transmitting an authentication response to a terminal when an authentication request is received from the terminal apparatus; transmitting a connection response to a terminal apparatus when a connection request is received from the terminal apparatus to which the authentication response has been transmitted; and carrying out data communication with the terminal to which the connection response has been transmitted. The carrying out data communication verifies a communication between another base station and the terminal apparatus, and carries out data communication with the terminal apparatus whose communication with the another base station apparatus has been verified even in the event that the connection processing unit has not transmitted the connection response to said terminal apparatus.

Still another embodiment of the present invention relates also to a communication method. This method comprises: receiving an authentication response from a base station apparatus when an authentication request is transmitted to the base station apparatus; receiving a connection response transmitted from a base station apparatus when a connection request is transmitted to the base station which has received the authentication response; and carrying out data communication with the base station apparatus which has received the connection response. When a connection has already been permitted by another base station apparatus, the carrying out data communication transmits to the base station apparatus a notification indicating that the connection has been permitted, in substitution for the authentication request, and carries out data communication with the base station apparatus.

Still another embodiment of the present invention relates also to a communication method. This method comprises: receiving an authentication response from a base station apparatus when an authentication request is transmitted to the base station apparatus; receiving a connection response transmitted from a base station apparatus when a connection request is transmitted to the base station which has received the authentication response; and carrying out data communication with the base station apparatus which has received the connection response. When a connection has already been permitted by another base station apparatus, the carrying out data communication carries out data communication with the base station apparatus even in the event that said base station apparatus has not received the connection response; and when data communication is rejected by the base station apparatus, the carrying out data communication transmits a notification indicating that a connection has already been permitted by another base station apparatus, in substitution for the authentication request, and carries out data communication with the base station apparatus.

Optional combinations of the aforementioned constituting elements, and implementations of the invention in the form of methods, apparatuses, systems, recording mediums, computer programs and so forth may also be effective as additional modes of the present invention.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 illustrates a structure of a communication system according to an embodiment of the present invention.

FIG. 2 is a sequence diagram showing a communication procedure in a communication system which is to be compared against the communication system of FIG. 1.

FIGS. 3(a) to 3(d) illustrate packet formats in the communication system of FIG. 1.

FIG. 4 illustrates a structure of a terminal apparatus shown in FIG. 1.

FIG. 5 illustrates a data structure of data stored in a storage shown in FIG. 4.

FIG. 6 illustrates a structure of a base station apparatus shown in FIG. 1.

FIG. 7 illustrates a data structure of data stored in a storage shown in FIG. 6.

FIG. 8 is a sequence diagram showing a communication procedure in a communication system shown in FIG. 1.

FIG. 9 is a flowchart showing a communication procedure in a terminal apparatus shown in FIG. 4.

FIG. 10 is a flowchart showing a communication procedure in a base station apparatus shown in FIG. 6.

FIG. 11 is a sequence diagram showing another communication procedure in a communication system shown in FIG. 1.

FIG. 12 is a flowchart showing another communication procedure in a terminal apparatus shown in FIG. 4.

FIG. 13 is a flowchart showing an interception procedure in a base station apparatus shown in FIG. 6.

FIG. 14 is a flowchart showing another communication procedure in a base station apparatus shown in FIG. 6.

### EXPLANATION OF REFERENCE

10 Terminal apparatus, 12 Base station apparatus, 14 Terminal antenna, 16 Base-station antenna, 20 Packet communication unit, 22 Signal processing unit, 24 State management unit, 26 Storage, 28 Packet receiver, 30 Packet transmitter, 32 Packet processing unit, 34 Packet generator, 50 Packet communication unit, 52 Signal processing unit, 54 Wired communication unit, 56 Packet receiver, 58 Packet transmitter, 60 Packet processing unit, 62 Packet generator, 64 Control unit, 66 Storage, 100 Communication system

### BEST MODE FOR CARRYING OUT THE INVENTION

The invention will now be described based on the following embodiments which do not intend to limit the scope of the present invention but exemplify the invention. All of the features and the combinations thereof described in the embodiments are not necessarily essential to the invention. An outline of the present invention will be given before a specific description thereof. Exemplary embodiments of the present invention relate to a communication system comprised of a base station apparatus and a terminal apparatus. An area within which the terminal apparatus can communicate with the base station apparatus is defined to be a communication area, whereas the communication area generally has an approximately circular shape with the base station apparatus as its center. As the terminal apparatus enters the communication area, a connection processing is performed between the terminal apparatus and the base station apparatus and then the data of the both apparatuses are communicated. When the terminal apparatus travels across the communication area, the terminal apparatus carries out the connection processing with another adjacent base station apparatus so as to performs a hand-over to the another base station apparatus.

If the terminal apparatus is mounted on a vehicle, the speed at which the terminal apparatus travels is high and therefore it is desired that a hand-over processing be performed at high speed. To carry out the hand-over processing at high speed, the base station apparatuses generally exchange information on the terminal apparatus with each other via a wired network. However, in order to simplify the hand-over processing, it is desired not to exchange the information via the wired network. In order to cope with such a problem as this, the communication system according to the present embodiment carries out the following processing.

When the connection processing between a base station apparatus and a terminal apparatus has been completed, information indicating that the connection has been permitted (this information will be hereinafter referred to as “authorization information”) is generated and then a packet containing the authorization information (this packet will be hereinafter referred to as “authorization packet”) is transmitted to the terminal apparatus. When the terminal apparatus receives the authorization packet, the terminal apparatus stores the authorization information. When performing the hand-over processing to another base station apparatus, the terminal apparatus transmits a data signal added with the authorization information to the another base station apparatus without executing the connection processing. Upon confirmation of the authorization information, the base station apparatus grants the connection and carries out data communication with the terminal apparatus. Accordingly, the connection processing is omitted, so that the hand-over is executed at high speed.

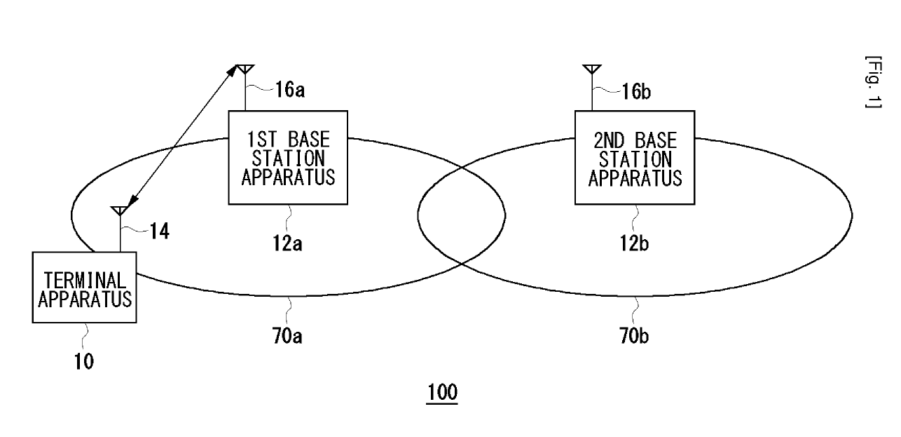

FIG. 1 illustrates a structure of a communication system 100 according to the present embodiment. The communication system 100 includes a terminal apparatus 10, and a first base station apparatus 12a and a second base station apparatus 12b, which are generically referred to as “base station apparatus 12”. The terminal apparatus 10 includes a terminal antenna 14. The first base station apparatus 12a includes a first base-station antenna 16a, whereas the second base station apparatus 12b includes a second base-station antenna 16b. The first base-station antenna 16a and the second base-station antenna 16b are generically referred to as “base-station antenna 16”. A first area 70a is an area covered by the first base station apparatus 12a, whereas a second area 70b is an area covered by the second base station apparatus 12b. The first area 70a and the second area 70b are generically referred to as “area 70”.

The first base station apparatus 12a and the second base station apparatus 12b are connected by a not-shown network. The first base station apparatus 12a forms the first area 70a via the first base-station antenna 16a, whereas the second base station apparatus 12b forms the second area 70b via the second base-station antenna 16b. The first area 70a and the second area 70b partially overlap with each other. The terminal apparatus 10 moves toward the first base station apparatus 12a from the outside of the first area 70a. As the terminal apparatus 10 enters the first area 70a, the terminal apparatus 10 performs the connection processing with the first base station apparatus 12a. After having completed the connection processing, the terminal apparatus 10 and the first base station apparatus 12a carries out data communication therebetween.

As the terminal apparatus 10 moves toward the second area 70b from the first area 70a, the hand-over processing is generally carried out from the first base station apparatus 12a to the second base station apparatus 12b. Here, the first base station apparatus 12 corresponds to a switching source, whereas the second base station apparatus 12b corresponds to a switching destination. If the information is exchanged between the first base station apparatus 12a and the second base station apparatus 12b via a network, the connection between the terminal apparatus 10 and the second base station 12b can be established by performing a processing which is simpler than the connection processing between the terminal apparatus 10 and the first base station apparatus 12a. However, as described above, it is assumed herein that the information is not exchanged via the network.

In such a case, the terminal apparatus 10 has to perform the connection processing between the terminal apparatus 10 and the second base station apparatus 12b as the terminal apparatus 10 enters the second area 70b. In the communication system 100, the following processing is performed in order to avoid such a connection processing. When the connection processing between the terminal apparatus 10 and the first base station apparatus 12a is terminated, the first base station apparatus 12a transmits an authorization packet to the terminal apparatus 10. The authorization packet contains authorization information, which means that the authentication processing and the connection processing for the terminal apparatus 10 have been completed by the first base station apparatus 12a.

When the terminal apparatus 10 receives the authorization packet, the terminal apparatus 10 stores the authorization information. As the terminal apparatus 10 enters the second area 70b, the terminal apparatus 10 transmits data added with the authorization information, to the second base station apparatus 12b. Upon confirmation of the received authorization information, the second base station apparatus 12b permits the data communication with the terminal apparatus 10 without performing the connection processing on the terminal apparatus 10. That is, the omission of the connection processing results in a prompt execution of hand-over processing, so that the data communication is immediately executed.

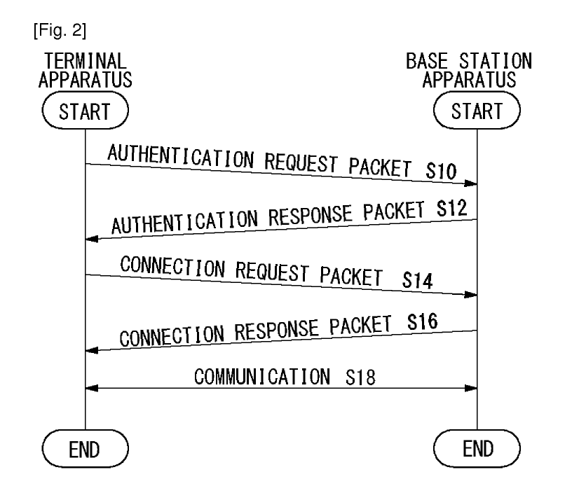

FIG. 2 is a sequence diagram showing a communication procedure in a communication system which is to be compared against the communication system 100. The terminal apparatus transmits an authentication request packet to the base station apparatus (S10). The base station apparatus transmits an authentication response packet to the terminal apparatus (S12). The terminal apparatus transmits a connection request packet to the base station apparatus (S14). The base station apparatus transmits a connection response packet to the terminal apparatus (S16). Then the terminal apparatus and the base station apparatus carry out data communication with each other (S18). Here, Step 10 to Step 16 correspond to the above-described connection processing. Accordingly, the terminal apparatus 10 and the first base station apparatus 12a shown in FIG. 1 execute Step 10 to Step 16 of FIG. 2.

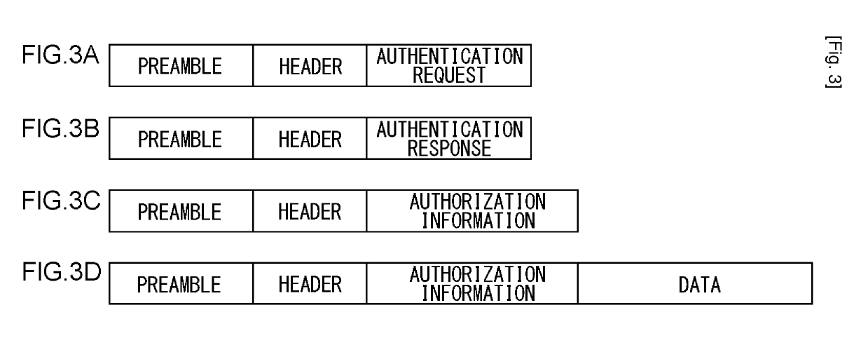

FIGS. 3(a) to 3(d) illustrate packet formats in the communication system 100. FIG. 3(a) illustrates the format of an authentication request packet, which is a signal transmitted in Step 10 of FIG. 2. “Preamble” is a known signal, which is also called a training signal. “Header” is a control signal. A content indicating that the base station apparatus 12 is requested to perform authentication is indicated in “authentication request”. FIG. 3(b) illustrates the format of an authentication response packet, which is the signal transmitted in Step 12 of FIG. 2. “Preamble” and “header” are the same as those shown in FIG. 3(a). An authentication result obtained in the base station apparatus 12 is indicated in “authentication response”. The connection request packet and the connection response packet in Step 14 and Step 16 of FIG. 2, respectively, are also formed in the similar manner to FIG. 3(a) and FIG. 3(b).

FIG. 3(c) illustrates the format of an authorization packet. The authorization packet is a signal transmitted from the first base station apparatus 12a to the terminal apparatus 10 when the first base station apparatus 12a has completed the connection processing with the terminal apparatus 10 in FIG. 1. “Preamble” and “header” are the same as those shown in FIG. 3(a). “Authorization information” contains the content indicating that a connection request has been completed, the identification number of the terminal apparatus 10 connected, the identification number of the base station apparatus 12 connected, an effective range and so forth. The effective range of the authorization information contains a period of validity, an effective area, and an effective number of times, which correspond to the length of time for which the authorization information is regarded effective, a setting area where the authorization information is regarded effective and the number of hand-overs for which the authorization information is regarded effective, respectively. For example, if the effective number of times is defined to be one, the authorization information will be limited to between adjacent base station apparatuses 12. FIG. 3(d) illustrates the format of a signal added with authorization information. This signal is one transmitted from the terminal to the second base station apparatus for the first time. “Preamble” and “header” are the same as those shown in FIG. 3(a). “Authorization information” contains the content indicating that a connection request has been completed, the identification number of the base station apparatus 12 already connected, the identification number of the terminal apparatus 10 already connected, an effective range and so forth.

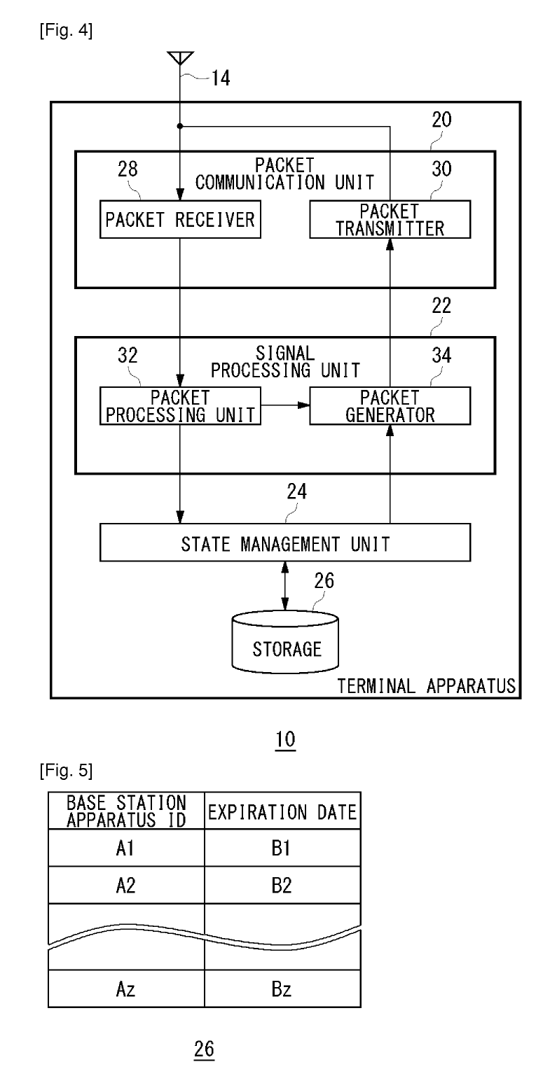

FIG. 4 illustrates a structure of a terminal apparatus 10. The terminal apparatus 10 includes a terminal antenna 14, a packet communication unit 20, a signal processing unit 22, a state management unit 24, and a storage 26. The packet communication unit 20 includes a packet receiver 28 and a packet transmitter 30. The signal processing unit 22 includes a packet processing unit 32 and a packet generator 34.

The packet receiver 28 performs demodulation processing and the like on a packet signal received by the terminal antenna 14. Since the packet signal received by the terminal antenna 14 is a radiofrequency-domain (RF-domain) signal, the packet receiver 28 carries out frequency conversion of the packet signal from the radiofrequency domain to the baseband domain. Then, the packet is subjected to demodulation processing and decoding processing, and a packet signal defined in an upper layer than a physical layer is outputted to the packet processing unit 32.

The packet processing unit 32 receives the packet signals from the packet receiver 28, and performs processings, in an upper layer, such as connection processing according to packet signals contained in the received packet signals. The upper layer corresponds to a layer which is defined higher than the physical layer. The packet processing unit 32 outputs a processing result to the state management unit 24 and, at the same time, gives instructions to the packet generator 34 about the next processing based on the processing result, particularly about the generation of packets to be transmitted.

The state management unit 24 receives the processing result obtained in the packet processing unit 32 and manages the state thereof. The state includes a connection processing state and a data communication state. Further, the connection processing state includes an authentication state and a connection state. The detail of processing performed by the state management unit 24 will be discussed later. While referring to the state managed by the state management unit 24, the packet generator 34 generates packet signals in accordance with instructions from the packet processing unit 32. Packet signals generated by the packet generator 34 are equivalent to packet signals defined in an upper layer than the physical layer, in correspondence to packet signals inputted to the packet processing unit 32. The packet generator 34 outputs the generated packet signals to the packet transmitter 30.

The packet transmitter 30 codes and modulates the packet signals outputted from the packet generator 34. Also, the packet transmitter 30 carries out frequency conversion of the modulated packet signals from the baseband domain to the radiofrequency domain. Then, the packet transmitter 30 transmits the frequency-converted packet signals from the terminal antenna 14. The processing performed by the packet receiver 28 and the packet transmitter 30 corresponds to a radio communication processing. And in the above-mentioned FIG. 1 the radio communication is so performed as to be able to access the base station apparatus 12.

Here, a description is specifically given of the processing by the state management unit 24. In a situation where the terminal apparatus enters the first area 70a, namely, in the situation where it is newly linked to the first base station apparatus 12a, the state management unit 24 transmits an authentication request packet to the first base station apparatus 12a via the packet generator 34 and the packet transmitter 30. Note that the detection of such a situation may be done using a known technology, based on a received power, for instance. Then the state management unit 24 receives an authentication response packet sent from the first base station apparatus 12a, via the packet receiver 28 and the packet processing unit 32. The state management unit 24 also transmits a connection request packet to the first base station apparatus 12a which has sent the authentication response packet, via the packet generator 34 and the packet transmitter 30. Further, the state management unit 24 receives a connection response packet sent from the first base station apparatus 12a. The above processing corresponds to Step 10 to Step 16 of FIG. 2, and is also called the connection processing.

After the connection processing, the state management unit 24 receives an authorization packet from the first base station apparatus 12a via the packet receiver 28 and the packet processing unit 32. The structure of the authorization packet is as shown in FIG. 3(c). As the state management unit 24 receives the authorization packet, the state management unit 24 extracts authorization information from the authorization packet and stores it in the storage 26. FIG. 5 illustrates a data structure of data stored in the storage 26. As shown in FIG. 5, the identification number of the base station apparatus 12 that has permitted the connection and the period of validity are stored. Refer back to FIG. 4. Then the state management unit 24 has the packet communication unit 20 and the signal processing unit 22 carry out data communication with the first base station apparatus 12a that has sent the connection response packet.

In a situation where the terminal apparatus moves to the second area 70b from the first area 70a, namely, in the situation where the hand-over processing is executed, and also in a case where the connection has already been granted from the first base station apparatus 12a which is the switching source, the state management unit 24 operates as follows. That is, the state management unit 24 transmits the authorization information stored in the storage 26, instead of the authorization request packet, to the second base station apparatus 12b which is the switching destination. At the same time, the state management unit 24 transmits a data packet to said second base station apparatus 12b via the packet generator 34 and the packet transmitter 30. Note that the detection of such a situation may also be done using a known technology, based on a received power, for instance. Note also that the authorization information and the data signal are contained in each packet signal as shown in FIG. 3(d).

Where such authorization information is permitted in the second base station apparatus 12b, namely, where the connection to the terminal apparatus 10 is granted, the state management unit 24 may receive the authorization packet from the second base station apparatus 12b via the packet receiver 28 and the packet processing unit 32 and may store the authorization information in the storage 26. Then the state management unit 24 has the packet communication unit 20 and the signal processing unit 22 carry out data communication with the second base station apparatus 12b that has sent the authorization packet. On the other hand, when the data communication is rejected by the second base station apparatus 12b that has received a data packet added with the authorization information, the state management unit 24 transmits an authentication request packet to said second base station apparatus 12b. In other words, the connection processing similar to that described above is executed.

This structure may be implemented hardwarewise by elements such as a CPU, memory and other LSIs of an arbitrary computer, and softwarewise by memory-loaded programs having communication functions or the like. Depicted herein are functional blocks implemented by cooperation of hardware and software. Therefore, it will be obvious to those skilled in the art that the functional blocks may be implemented by a variety of manners including hardware only, software only or a combination of both.

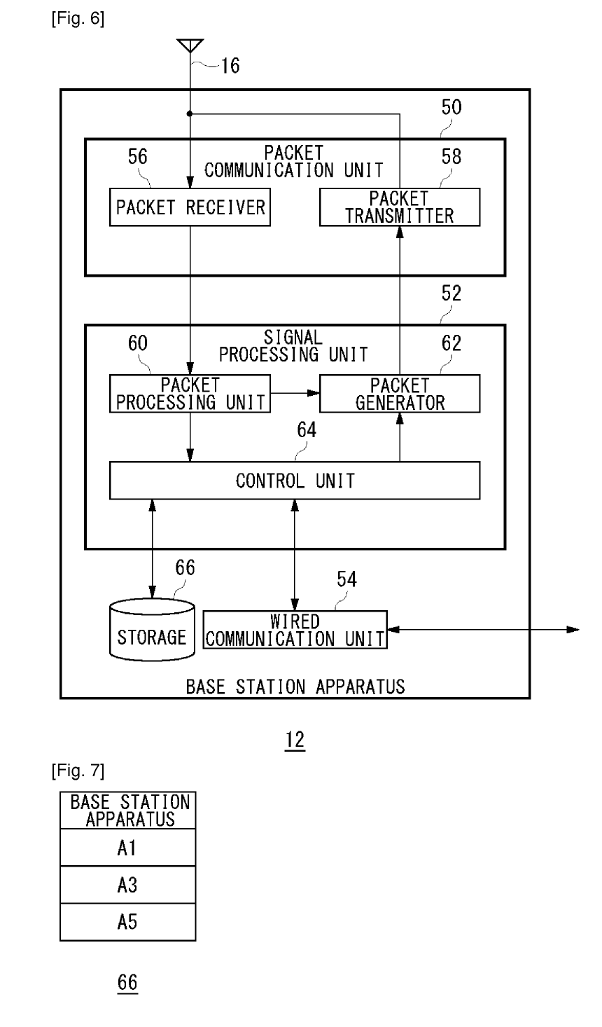

FIG. 6 illustrates a structure of a base station apparatus 12. The base station apparatus 12 includes a base-station apparatus antenna 16, a packet communication unit 50, a signal processing unit 52, a wired communication unit 54, and a storage 66. The packet communication unit 50 includes a packet receiver 56 and a packet transmitter 58. The signal processing unit 52 includes a packet processing unit 60, a packet generator 62, and a control unit 64.

The packet receiver 56 performs processing similar to that of the above-described packet receiver 28, whereas the packet transmitter 58 performs processing similar to that of the above-described packet transmitter 30. Note that the packet transmitter 58 transmits a beacon signal at regular intervals. The beacon signal contains information by which to identify the base station apparatus 12.

The packet processing unit 60 receives a packet signal from the packet receiver 56, and performs processing for an upper layer, such as a connection processing, according to the packet signal contained in the received packet signal. The upper layer corresponds to a layer defined upper than a physical layer. The packet processing unit 60 outputs a processing result to the control unit 64. The control unit 64 controls the operation of the entire base station apparatus 12, the connection processing for the terminal apparatus 10, and the like. The detail of the control unit 64 will be described later.

The packet generator 62 generates packet signals according to instructions from the control unit 64. Note that the packet signal generated by the packet generator 62, which corresponds to the packet signal inputted to the packet processing unit 60, is equivalent to a packet signal defined in a layer upper than a physical layer. The packet generator 62 outputs the generated packet signal to the packet transmitter 58.

The wired communication unit 54 is connected to a not-shown wired network, and performs the wired communication that uses the wired network. That is, the wired communication unit 54 outputs data, sent from a not-shown terminal apparatus 10, received by the packet communication unit 50 and the signal processing unit 52 to the wired network. Also, the wired communication unit 54 outputs data inputted from the wired network, to the signal processing unit 52. Note that the control of the wired communication unit 54 is performed by the control unit 64.

A specific description is given here of the processing in the control unit 64. If the base station apparatus 12 is equivalent to the first base station apparatus 12a of FIG. 1, the control unit 64 will receive an authentication request packet sent from the terminal apparatus 10, via the packet receiver 56 and the packet processing unit 60. After having authenticated the terminal apparatus 10, the control unit 64 transmits an authentication response packet to said terminal apparatus 10 via the packet generator 62 and the packet transmitter 58. Then the control unit 64 receives, via the packet receiver 56 and the packet processing unit 60, a connection request packet from the terminal apparatus 10 to which the authentication response packet has been transmitted.

After having determined the connection to the terminal apparatus 10, the control unit 64 transmits a connection response packet to said terminal apparatus 10 via the packet generator 62 and the packet transmitter 58. The above-described processing corresponds to Step 10 to Step 16 of FIG. 2. Also, the control unit 64 transmits an authorization packet shown in FIG. 3(c) to the terminal apparatus 10 connected. The authorization packet is as shown above, so that the explanation thereof is omitted here. Then the control unit 64 has the packet communication unit 50 and the signal processing unit 52 carry out data communication with the terminal apparatus 10 that has received the connection response packet.

If the base station apparatus 12 corresponds to the second base station apparatus 12b of FIG. 1, the control unit 64 will receive authorization information indicating that the connection has already been granted by another base station apparatus 12, instead of the authorization request packet, from terminal apparatus 10 via the packet receiver 56 and the packet processing unit 60. Here, the authorization information forms a data signal and at the same time one packet signal as shown in FIG. 3(d). Note that the information on the other base station apparatuses 12 is stored beforehand in the storage 66. Here, the information on the other base station apparatuses 12 is information on base station apparatuses 12 which perform the connection processing on behalf of a base station apparatus 12. That is, if the identification numbers of the base station apparatuses 12 contained in the authorization information received from the terminal apparatus 10 are stored in the storage 66, the control unit 64 will permit the connection of said terminal apparatus 10.

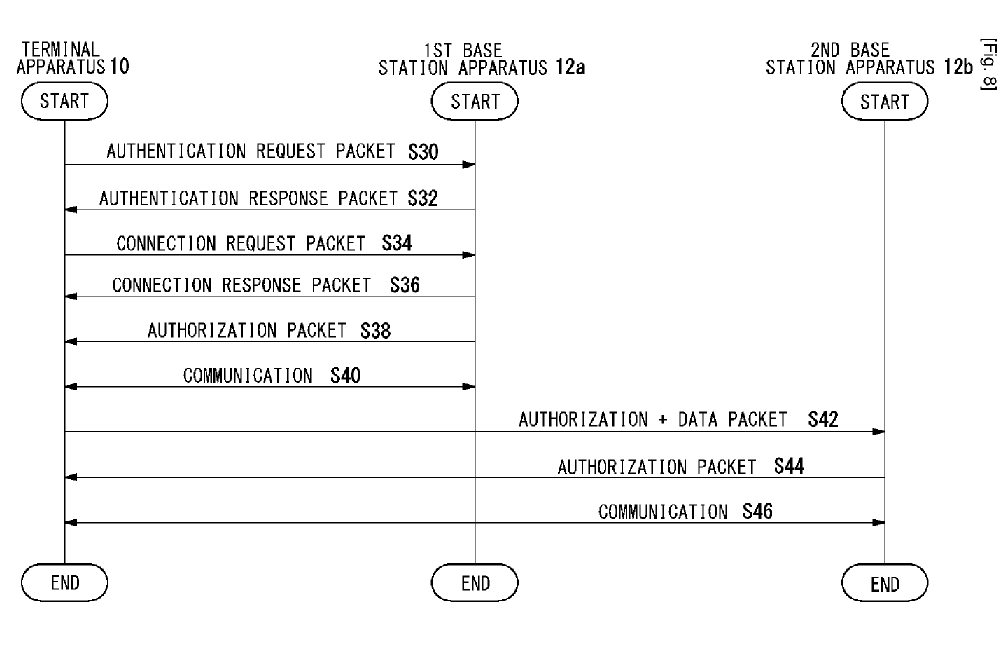

On the other hand, if the identification numbers of the base station apparatuses 12 contained in the authorization information received from the terminal apparatus 10 are not stored in the storage 66, the control unit 64 will reject the connection of said terminal apparatus 10. FIG. 7 illustrates a data structure of data stored in the storage 66. As shown in FIG. 7, the identification numbers of the base station apparatuses 12 that perform the connection on behalf thereof are shown. Refer back to FIG. 6. Then the control unit 64 has the packet communication unit 50 and the signal processing unit 52 carry out data communication with said terminal apparatus 10.

An operation of the communication system 100 structured as above is explained. FIG. 8 is a sequence diagram showing a communication procedure in the communication system 100. The terminal apparatus 10 transmits an authentication request packet to the first base station apparatus 12a (S30). The first base station apparatus 12a transmits an authentication response packet to the terminal apparatus 10 (S32). The terminal apparatus 10 transmits a connection request packet to the first base station apparatus 12a (S34). The first base station apparatus 12a transmits a connection response packet to the terminal apparatus 10 (S36). Also, the first base station apparatus 12 transmits an authorization packet to the terminal apparatus 10 (S38), so that a communication processing is carried out between the terminal apparatus 10 and the first base station apparatus 12a (S40).

Then the terminal apparatus 10 transmits a data packet added with the authorization information, to the second base station apparatus 12b (S42). The second base station apparatus 12b may transmit an authorization packet to the terminal apparatus 10 (S44). At the same time, the second base station apparatus 12b may update the authorization information. Further, communication processing is performed between the terminal apparatus 10 and the second base station apparatus 12b (S46).

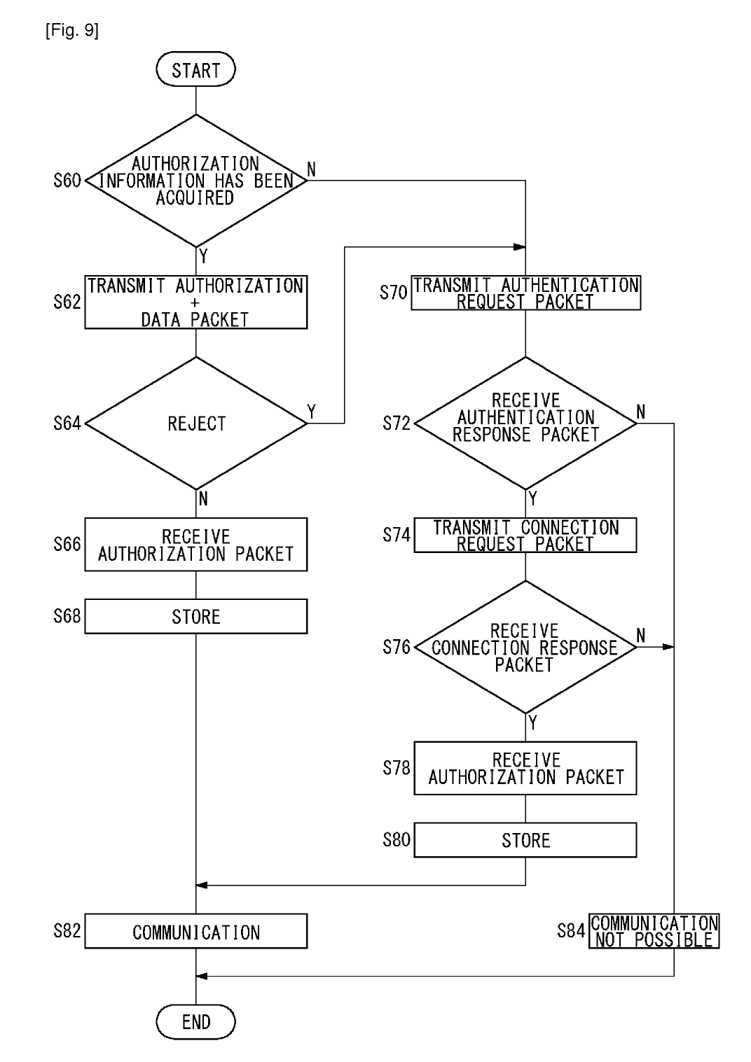

FIG. 9 is a flowchart showing a communication procedure in the terminal apparatus 10. If the storage 26 has not yet acquired the authorization information (N of S60), the state management unit 24 will transmit an authentication request packet via the packet generator 34 and the packet transmitter 30 (S70). If an authentication response packet is received via the packet receiver 28 and the packet processing unit 32 (Y of S72), the state management unit 24 will transmit a connection request packet via the packet generator 34 and the packet transmitter 30 (S74). If a connection response packet is received via the packet receiver 28 and the packet processing unit 32 (Y of S76), the state management unit 24 will receive an authorization packet via the packet receiver 28 and the packet processing unit 32 (S78). The state management unit 24 stores the authorization information contained in the authorization packet, in the storage 26 (S80). Then the packet communication unit 20 and the signal processing unit 22 execute communications (S82).

If, on the other hand, the storage 26 has received the authorization information (Y of S60), the state management unit 24 will transmit a data packet added with the authorization information, via the packet generator 34 and the packet transmitter 30 (S62). If not rejected (N of S64), the state management unit 24 will receive the authorization packet via the packet receiver 28 and the packet processing unit 32 (S66). The state management unit 24 stores the authorization information contained in the authorization packet, in the storage 26 (S68). Note that the processings of Step 66 and Step 68 may be skipped. Then the packet communication unit 20 and the signal processing unit 22 execute communications (S82). If rejected (Y of S64), the processing from Step 70 onward will be executed. If the authentication response packet is not received via the packet receiver 28 and the packet processing unit 32 (N of S72) or if the connection response packet is not received via the packet receiver 28 and the packet processing unit 32 (N of S76), the communication will not be possible (S84).

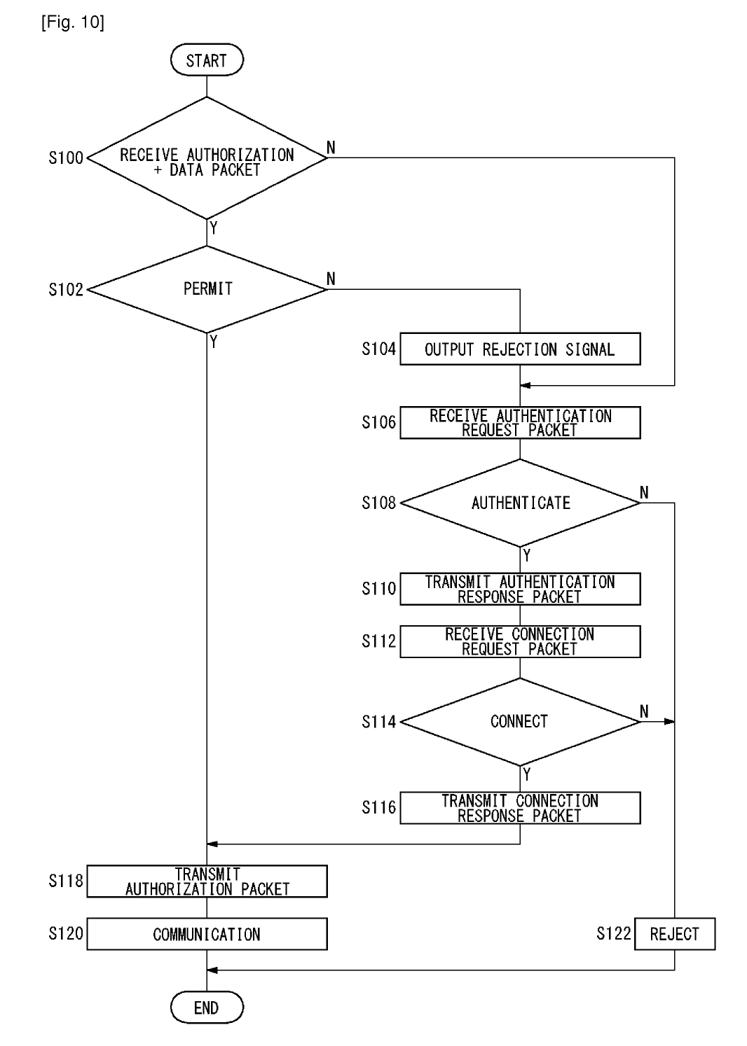

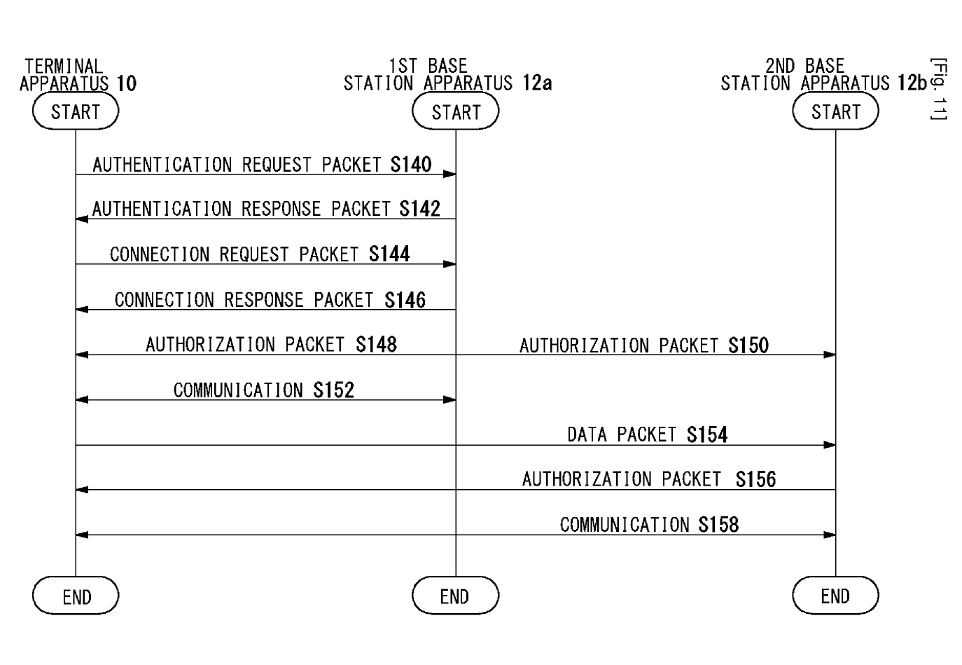

FIG. 10 is a flowchart showing a communication procedure in the base station apparatus 12. If the data packet added with the authorization information is received (Y of S100) and a permission is granted referring to the storage 66 (Y of S102), the control unit 64 will transmit the authorization packet via the packet generator 62 and the packet transmitter 58 (S118). Note that the processing of Step 118 may be skipped. Then the packet communication unit 50 and the signal processing unit 52 execute communications (S120).

If, on the other hand, not granted (N of S102), the control unit 64 will output a rejection signal via the packet generator 62 and the packet transmitter 58 (S104). The control unit 64 receives the authentication request packet via the packet receiver 56 and the packet processing unit 60 (S106). If authenticated (Y of S108), the control unit 64 will transmit the authentication response packet via the packet generator 62 and the packet transmitter 58 (S110). Also, the control unit 64 receives the connection request packet via the packet receiver 56 and the packet processing unit 60 (S112). If a connection is determined (Y of S114), the control unit 64 will transmit the connection response packet via the packet generator 62 and the packet transmitter 58 (S116). The control unit 64 transmits the authorization packet via the packet generator 62 and the packet transmitter 58 (S118). Then the packet communication unit 50 and the signal processing unit 52 execute communications (S120).

If the data packet added with the authorization information is not received (N of S100), the control unit 64 will execute the processing from Step 106 onward. If not authenticated (N of S108) or if the connection is not determined (N of S114), the control unit 64 will reject the connection (S122).

Another exemplary embodiment is described hereinbelow. An objective of this another exemplary embodiment is to more simplify the processing of the switching destination in the hand-over processing than in the previously described exemplary embodiment. The base station apparatus 12, which is the switching destination, intercepts beforehand the authorization packet transmitted from the base station apparatus 12, which is the switching source. When the hand-over processing is conducted from the switching-source base station apparatus 12 to the switching-destination base station apparatus 12, the terminal apparatus 10 transmits a data packet to the switching-destination base station apparatus 12. At that time, the authentication request packet and authorization information is not transmitted.

The switching-destination base station apparatus 12 verifies if the received data packet is the packet sent from the terminal apparatus 10 that has intercepted the authorization packet or not. If it is the packet sent from the terminal apparatus 10 that has intercepted the authorization packet, the switching-destination base station apparatus 12 will grant the connection of said terminal apparatus 10. The communication system 100 according to the another exemplary embodiment is of the same type as FIG. 1; the terminal apparatus 10 according to the another exemplary terminal 10 is of the same type as FIG. 4; and the base station apparatus 12 according to the another exemplary embodiment is the same type as FIG. 6.

A specific description is given here of the processing in the state management unit 24 of the terminal apparatus 10. The processing performed in a situation where the terminal apparatus enters the first area 70a in FIG. 1, namely, in the situation where it is newly linked to the first base station apparatus 12a, is similar to that of the exemplary embodiment, so that explanation thereof is omitted here. On the other hand, if the connection has been granted by the first base station apparatus 12a, which is the switching source, in a situation where the terminal apparatus moves from the first area 70a to the second area 70b in FIG. 1, namely, in the situation where the hand-over processing is executed, the state management unit 24 will transmit the data packet to the second base station apparatus that has not received the connection response packet, via the packet generator 34 and the packet transmitter 30.

If the transmission of the data packet is permitted by the second base station apparatus 12b, namely, if the connection to the terminal apparatus 10 is permitted, the state management unit 24 may receive an authorization packet from the second base station apparatus 12b which is the switching destination, via the packet receiver 28 and the packet processing unit 32. In such a case, the authorization information is stored in the storage 26. Then the state management unit 24 has the packet communication unit 20 and the signal processing unit 22 carry out data communication with the second base station apparatus 12b.

On the other hand, when the data communication is rejected by said second base station apparatus 12b, the state management unit 24 transmits the authorization information stored in the storage 26, instead of the authentication request packet, to the second base station apparatus 12b and transmits the data packet to said second base station apparatus 12b via the packet generator 34 and the packet transmitter 30. The authorization information and the data signal are contained in each packet signal as shown in FIG. 3(d).

If the authorization information is permitted by the second base station apparatus 12b, namely, if the connection to the terminal apparatus 10 is permitted, the state management unit 24 may receive an authorization packet from the second base station apparatus 12b which is the switching destination, via the packet receiver 28 and the packet processing unit 32. In such a case, the authorization information is stored in the storage 26. Then the state management unit 24 has the packet communication unit 20 and the signal processing unit 22 carry out the data communication with the second base station apparatus 12b. If, on the other hand, when the data communication is rejected by the second base station apparatus 12b which has been transmitted the data packet added with the authorization information, the state management unit 24 transmits an authorization request packet to said second base station apparatus 12b. That is, the connection processing is executed.

Next, a specific description is given of the processing in the control unit 64 of the base station apparatus 12. If the base station apparatus 12 corresponds to the first base station apparatus 12a of FIG. 1, the processing executed by the control unit 64 will be the same as that in the exemplary embodiment, so that the description thereof is omitted here. The control unit 64 verifies the communication between another base station apparatus 12 and the terminal apparatus 10. More specifically, the control unit 64 in the second base station apparatus 12b shown in FIG. 1 intercepts the authorization packet sent from the first base station apparatus 12a to the terminal apparatus 10, via the packet receiver 56 and the packet processing unit 60. Further, the control unit 64 extracts the authorization information from the intercepted authorization packet and stores it in the storage 66. It is to be noted that the identification number of the terminal apparatus 10 which is the address of the authorization packet is contained in the authorization information. This can be said to be the identification number of the terminal 10 to which the connection is granted by the first base station apparatus 12a of FIG. 1. Such a processing as this is executed in such an environment where a plurality of base station apparatuses are provided adjacently and a signal from other base station apparatuses 12 can be received.

The control unit 64 in the second base station apparatus 12b of FIG. 1, namely, the base station apparatus 12 which is a switching destination of the hand-over processing, receives the data packet from the terminal apparatus 10 which does not transmit the connection response packet, via the packet receiver 56 and the packet processing unit 60. Here, the terminal apparatus 10 to which the connection response packet is not transmitted corresponds to a terminal apparatus 10 to which the connection is not permitted. The control unit 64 identifies the terminal apparatus 10, which has transmitted the data packet, by verifying the contents of the data packet. The control unit 64 reads the identification number of the terminal apparatus 10, from the authorization information stored in the storage 66 and verifies if the identified identification number is contained in the read-out identification information or not.

If it is contained in the read-out information, the control unit 64 may permit the connection to said terminal apparatus 10 and transmit the authorization packet via the packet generator 62 and the packet transmitter 58. The control unit 64 has the packet communication unit 50 and the signal processing unit 52 carry out data communication with the terminal apparatus 10 to which the connection has been granted. If, on the other hand, it is not contained therein, the control unit 64 will reject the connection to said terminal apparatus 10. Then the control unit 64 receives the data packet added with the authorization information, via the packet receiver 56 and the packet processing unit 60 from the terminal apparatus to which the connection has been rejected. The processing after this is the same as that of the exemplary embodiment, so that the description thereof is omitted.

FIG. 11 is a sequence diagram showing a communication procedure in the communication system 100. The terminal apparatus 10 transmits an authentication request packet to the first base station apparatus 12a (S140). The first base station apparatus 12a transmits an authentication response packet to the terminal apparatus 10 (S142). The terminal apparatus 10 transmits a connection request packet to the first base station apparatus 12a (S144). The first base station apparatus 12a transmits a connection response packet to the terminal apparatus 10 (S146). Also, the first base station apparatus 12 transmits an authorization packet to the terminal apparatus 10 (S148). Note that said authorization packet is also intercepted by the second base station apparatus 12b (S150). Then the communication processing is carried out between the terminal apparatus 10 and the first base station apparatus 12a (S152).

Then the terminal apparatus 10 transmits a data packet to the second base station apparatus 12b (S154). The second base station apparatus 12b may transmit an authorization packet to the terminal apparatus 10 (S156). Further, the communication processing is performed between the terminal apparatus 10 and the second base station apparatus 12b (S158).

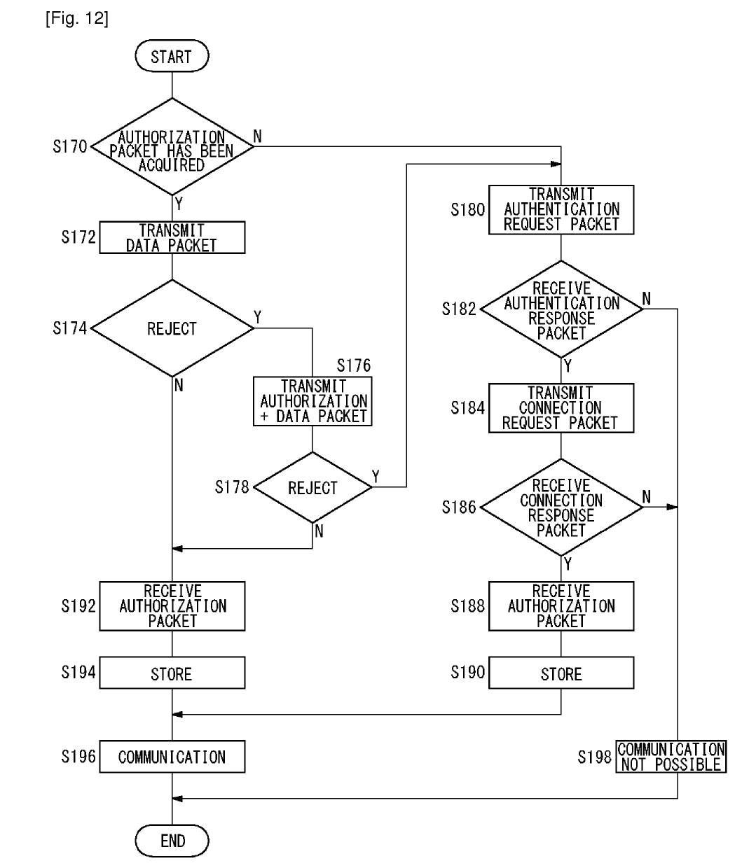

FIG. 12 is a flowchart showing another communication procedure in the terminal apparatus 10. If the storage 26 has not yet acquired the authorization information (N of S170), the state management unit 24 will transmit an authentication request packet via the packet generator 34 and the packet transmitter 30 (S180). If an authentication response packet is received via the packet receiver 28 and the packet processing unit 32 (Y of S182), the state management unit 24 will transmit a connection request packet via the packet generator 34 and the packet transmitter 30 (S184). If a connection response packet is received via the packet receiver 28 and the packet processing unit 32 (Y of S186), the state management unit 24 will receive an authorization packet via the packet receiver 28 and the packet processing unit 32 (S188). The state management unit 24 stores the authorization information contained in the authorization packet, in the storage 26 (S190). Then the packet communication unit 20 and the signal processing unit 22 execute communications (S196).

If, on the other hand, the storage 26 has received the authorization information (Y of S170), the state management unit 24 will transmit a data packet via the packet generator 34 and the packet transmitter 30 (S172). If rejected (Y of S174), the state management unit 24 will transmit a data packet added with the authorization information (S176). If not rejected (N of S178), the state management unit 24 will receive the authorization packet via the packet receiver 28 and the packet processing unit 32 (S192). The state management unit 24 stores the authorization information contained in the authorization packet, in the storage 26 (S194). Note that the processings of Step 192 and Step 194 may be skipped. Then the packet communication unit 20 and the signal processing unit 22 execute communications (S196). If rejected (Y of S178), the processing from Step 180 onward will be executed.

If not rejected (N of S174), the state management unit 24 will receive the authorization packet via the packet receiver 28 and the packet processing unit 32 (S192). The state management unit 24 stores the authorization information contained in the authorization packet, in the storage 26 (S194). Then the packet communication unit 20 and the signal processing unit 22 execute communications (S196). If the authentication response packet is not received via the packet receiver 28 and the packet processing unit 32 (N of S182) or if the connection response packet is not received via the packet receiver 28 and the packet processing unit 32 (N of S186), the communication will not be possible (S198).

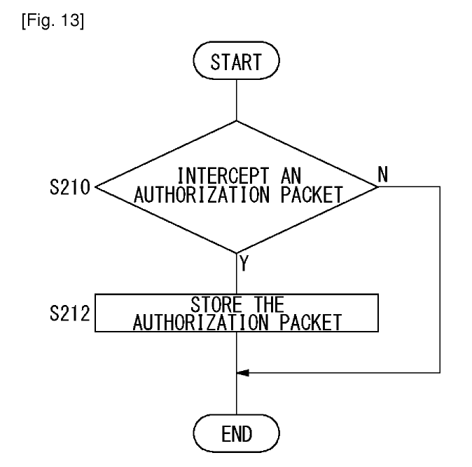

FIG. 13 is a flowchart showing an interception procedure in the base station apparatus 12. If the control unit 64 intercepts the authorization packet via the packet receiver 56 and the packet processing unit 60 (Y of S210), the control unit 64 will store the authorization information contained in the authorization packet, in the storage 66 (S212). If, on the other hand, the control unit 64 does not intercept the authorization packet via the packet receiver 56 and the packet processing unit 60 (N of S210), the processing will be terminated.

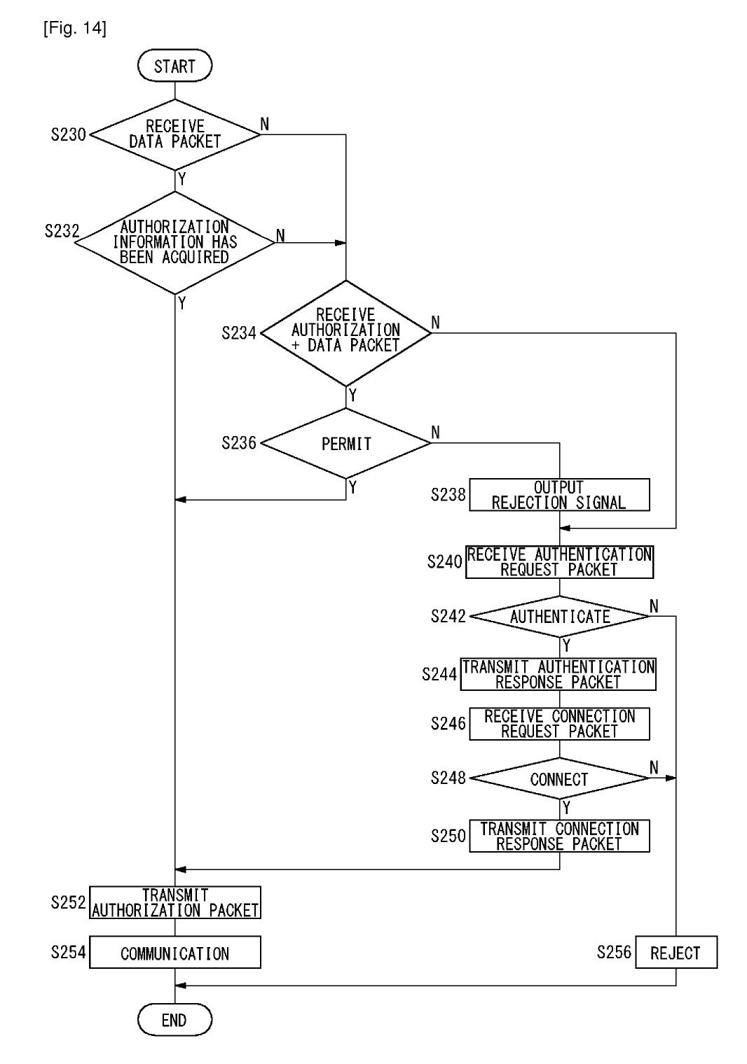

FIG. 14 is a flowchart showing another communication procedure in the base station apparatus 12. The control unit 64 receives the data packet (Y of S230). And if the storage 66 has already acquired the authorization information (Y of S232), the control unit 64 will transmit the authorization packet via the packet generator 62 and the packet transmitter 58 (S252). Note that the processing of Step 252 may be skipped. Then the packet communication unit 50 and the signal processing unit 52 execute communications (S254). If, on the other hand, it does not receive the data packet (N of S230) or the storage 66 has not yet acquired the authorization information (N of S232), the control unit 64 will receive the data packet added with the authorization information (Y of S234). And if it gives permission referring to the storage 66 (S236), the control unit 64 will transmit the authorization packet via the packet generator 62 and the packet transmitter 58 (S252). Then the packet communication unit 50 and the signal processing unit 52 execute communications (S254).

If it does not grant the permission (N of S236), the control unit 64 will output a rejection signal via the packet generator 62 and the packet transmitter 58 (S238). The control unit 64 receives an authentication request packet via the packet receiver 56 and the packet processing unit 60 (S240). If authenticated (Y of S242), the control unit 64 will transmit an authentication response packet via the packet generator 62 and the packet transmitter 58 (S244). The control unit 64 receives a connection request packet via the packet receiver 56 and the packet processing unit 60 (S246). If the connection is determined (Y of S248), the control unit 64 will transmit a connection response packet via the packet generator 62 and the packet transmitter 58 (S250). The control unit 64 transmits the authorization packet via the packet generator 62 and the packet transmitter 58 (S252). Then the packet communication unit 50 and the signal processing unit 52 execute communications (S254).

If the data packet added with the authorization information is not received (N of S234), the control unit 64 will execute the processing from Step 240 onward. If not authenticated (N of S242) or if the connection is not determined (N of S248), the control unit 64 will reject the connection (S256).

According to the present embodiment, upon receipt of the authorization information instead of the authentication request packet, the data communication is carried out with the said terminal apparatus and therefore the connection processing is omitted. Thus, the length of time required for the connection processing between the base station apparatus and the terminal apparatus can be shortened. If the received authorization information agrees with the authorization information stored, the connection to the terminal apparatus will be granted, so that the safety provided by security can be enhanced. Since the authorization information and the data are contained in the same packet signal, the transmission efficiency can be improved. When a connection has been completed, the base station apparatus transmits the authorization packet, so that the authorization information managed by the terminal apparatus can be updated. The provision of the period of validity can enhance the safety provided by security. Since the authorization information is transmitted in substitution for the authentication request packet, the connection processing is omitted. Hence, the length of period required for the connection processing between the base station apparatus and the terminal apparatus can be shortened. Also, the authentication request packet is transmitted when the authorization information is rejected. Thus the hand-over is carried out without fail.

When an authorization packet from another base station to the terminal apparatus can be intercepted, the data communication can be carried out without the transmission of a connection response packet to said terminal apparatus. This arrangement omits the connection processing, so that the length of period required for the connection processing between the base station apparatus and the terminal apparatus can be shortened. Even when a base station to be connected receives only a data packet from the terminal apparatus, the base station permits said terminal apparatus to access thereto. Hence, the length of period required for the connection processing can be shortened. Where the authorization packet has not been intercepted beforehand, the base station apparatus to be connected does not permit said terminal apparatus to access thereto when it receives only a data packet from said terminal apparatus. Hence, the safety provided by security can be enhanced. If the data communication is carried out instead of transmitting the authentication request packet from the terminal apparatus and if the access is rejected by the base station apparatus, said terminal apparatus transmits the authorization information so as to omit the connection processing. Therefore, the length of period required for the connection processing between the base station apparatus and the terminal apparatus can be reduced.

The present invention has been described based on the exemplary embodiments. These exemplary embodiments are intended to be illustrative only, and it is understood by those skilled in the art that various modifications to constituting elements and processes could be developed and that such modifications are also within the scope of the present invention.

In the exemplary embodiments according to the present invention, the terminal apparatus appends data to the authorization information and transmits this data added with the authorization information. However, this should not be considered as limiting, and the terminal apparatus 10 may transmit the authorization information only. With this modification, too, the base station apparatus 12 can acquire the authorization information.

In the exemplary embodiments according to the present invention, the base station apparatus 12, which is a switching destination of the hand-over processing, intercepts the authorization packet sent to the terminal apparatus 10 from the base station apparatus 12, which is a switching source thereof. However, this should not be considered as limiting, and the switching-destination base station apparatus 12 may intercept the data packet between the switching-source base station apparatus 12 and the terminal apparatus 10. In so doing, the switching-destination base station apparatus 12 generates authorization information by analyzing the destination and the sender of the data packet. According to this modification, the authorization information can be acquired even in the event that the receiving of the authorization packet fails.

While the preferred embodiments of the present invention have been described using specific terms, such description is for illustrative purposes only, and it is to be understood that changes and variations may be made without departing from the spirit or scope of the appended claims.

### INDUSTRIAL APPLICABILITY

The length of period required for processing the connection between base station apparatuses and a terminal apparatus within a communication area formed by the base station apparatuses can be reduced.

1. A base station apparatus, comprising:
a connection processing unit including:
a first transmitting means which transmits an authentication response to a terminal apparatus when an authentication request is received from said terminal apparatus; and
a second transmitting means which transmits a connection response to a terminal apparatus when a connection request is received from said terminal apparatus to which the authentication response has been transmitted; and
a communication unit which carries out data communication with the terminal apparatus to which said connection processing unit has transmitted the connection response,
wherein when said connection processing unit receives, from a terminal apparatus, a notification indicating that a connection has already been permitted by another base station apparatus in substitution for the authentication request, said communication unit carries out data communication with said terminal apparatus.

2. A base station apparatus according to claim 1, wherein said connection processing unit and said communication unit receive, from a terminal signal, a packet signal containing the notification indicating that a connection has already been permitted by another base station apparatus and a data signal.

3. A base station apparatus according to claim 1, further comprising a storage which stores beforehand information on another base station apparatus, wherein when the information on another base station apparatus contained in the notification received by said connection processing unit is contained in the storage, said communication unit carries out data communication with the terminal apparatus.

4. A base station apparatus, comprising:
a connection processing unit including:
a first transmitting means which transmits an authentication response to a terminal apparatus when an authentication request is received from the terminal apparatus; and
a second transmitting means which transmits a connection response to a terminal apparatus when a connection request is received from said terminal apparatus to which the authentication response has been transmitted; and
a communication unit which carries out data communication with the terminal apparatus to which said connection processing unit has transmitted the connection response,
wherein said connection processing unit verifies a communication between another base station and the terminal apparatus, and
wherein said communication unit carries out data communication with the terminal apparatus whose communication with the another base station apparatus has been verified by said connection processing unit even in the event that said connection processing unit has not transmitted the connection response to said terminal apparatus.

5. A terminal apparatus, comprising:
a connection processing unit including:
a first receiving means which receives an authentication response transmitted from a base station apparatus when an authentication request is transmitted to said base station apparatus; and
a second receiving means which receives a connection response from a base station apparatus when a connection request is transmitted to said base station apparatus which has received the authentication response; and
a communication unit which carries out data communication with the base station apparatus from which said connection processing unit has received the connection response,
wherein when said connection processing unit has already been permitted a connection by another base station apparatus, said communication unit transmits to the base station apparatus a notification indicating that the connection has been permitted, in substitution for the authentication request, and carries out data communication with the base station apparatus.

6. A terminal apparatus, comprising:
a connection processing unit including:
a first receiving means which receives an authentication response transmitted from a base station apparatus when an authentication request is transmitted to said base station apparatus; and
a second receiving means which receives a connection response from a base station apparatus when a connection request is transmitted to said base station apparatus which has received the authentication response; and
a communication unit which carries out data communication with the base station apparatus from which said connection processing unit has received the connection response,
wherein when said connection processing unit has already been permitted a connection by another base station apparatus, said communication unit carries out data communication with the base station apparatus even in the event that said connection processing unit has not received the connection response from said base station apparatus; and when data communication is rejected by the base station apparatus, said communication unit transmits a notification indicating that a connection has already been permitted by another base station apparatus, in substitution for the authentication request, and carries out data communication with the base station apparatus.

7. A terminal apparatus according to claim 5, wherein said communication unit transmits, to the base station apparatus, a packet signal containing the notification indicating that the connection has been permitted by another base station apparatus and a data signal.

8. A terminal apparatus according to claim 5, wherein when a base station apparatus rejects data communication with said communication unit, said connection processing unit transmits an authentication request to said base station apparatus.

9. A communication method, comprising:
transmitting an authentication response to a terminal when an authentication request is received from the terminal apparatus;
transmitting a connection response to a terminal apparatus when a connection request is received from the terminal apparatus to which the authentication response has been transmitted; and
carrying out data communication with the terminal to which the connection response has been transmitted,
wherein when a notification indicating that a connection has already been permitted by another base station apparatus is received, in substitution for the authentication request, from the terminal apparatus, said carrying out data communication carries out data communication with said terminal apparatus.

10. A communication method, comprising:
transmitting an authentication response to a terminal when an authentication request is received from the terminal apparatus;
transmitting a connection response to a terminal apparatus when a connection request is received from the terminal apparatus to which the authentication response has been transmitted; and
carrying out data communication with the terminal to which the connection response has been transmitted,
wherein said carrying out data communication verifies a communication between another base station and the terminal apparatus, and carries out data communication with the terminal apparatus whose communication with the another base station apparatus has been verified even in the event that said connection processing unit has not transmitted the connection response to said terminal apparatus.

11. A communication method, comprising:
receiving an authentication response from a base station apparatus when an authentication request is transmitted to the base station apparatus;
receiving a connection response transmitted from a base station apparatus when a connection request is transmitted to the base station which has received the authentication response; and carrying out data communication with the base station apparatus which has received the connection response,
wherein when a connection has already been permitted by another base station apparatus, said carrying out data communication transmits to the base station apparatus a notification indicating that the connection has been permitted, in substitution for the authentication request, and carries out data communication with the base station apparatus.

12. A communication method, comprising:
receiving an authentication response from a base station apparatus when an authentication request is transmitted to the base station apparatus;
receiving a connection response transmitted from a base station apparatus when a connection request is transmitted to the base station which has received the authentication response; and
carrying out data communication with the base station apparatus which has received the connection response,
wherein when a connection has already been permitted by another base station apparatus, said carrying out data communication carries out data communication with the base station apparatus even in the event that said base station apparatus has not received the connection response; and
when data communication is rejected by the base station apparatus, said carrying out data communication transmits a notification indicating that a connection has already been permitted from another base station, in substitution for the authentication request, and carries out data communication with the base station apparatus.

13. A terminal apparatus according to claim 6, wherein said communication unit transmits, to the base station apparatus, a packet signal containing the notification indicating that the connection has been permitted by another base station apparatus and a data signal.

14. A terminal apparatus according to claim 6, wherein when a base station apparatus rejects data communication with said communication unit, said connection processing unit transmits an authentication request to said base station apparatus.
